(19) United States
(12) Patent Application Publication
(10) Pub. No.: US 2011/0140848 A1
(43) Pub. Date: Jun. 16, 2011

(54) BROADCAST RECEIVER

(76) Inventors: Masahiro Abukawa, Tokyo (JP); Shu Murayama, Tokyo (JP); Naoyuki Tsushima, Tokyo (JP); Shinji Akatsu, Tokyo (JP); Nobuyoshi Okumura, Tokyo (JP); Tsuyoshi Kasaura, Tokyo (JP)

(21) Appl. No.: 12/674,866

(22) PCT Filed: Aug. 24, 2007
(86) PCT No.: PCT/JP2007/066472

§ 371 Date: Feb. 23, 2010

(51) Int. Cl. G08B 25/00

(52) U.S. Cl. 340/8.1

(57) ABSTRACT

A broadcast receiver stores history information about switching between sending-out stations, the history information including broadcast display state information, in a storage unit 7 while bringing the history information into correspondence with position information about a position of a vehicle, and compares current broadcast display state information acquired at a current position of the vehicle with broadcast display state information in history information which is extracted from the storage unit 7 and which corresponds to a position which is the same as the current position to determine that a sending-out station corresponding to history information which provides a display state which is the same as the display state of a broadcast wave currently being received as the vehicle travels is a switching destination.

### FIELD OF THE INVENTION

The present invention relates to a broadcast receiver mounted in a moving object such as a vehicle.

### BACKGROUND OF THE INVENTION

A conventional broadcast receiver disclosed by patent reference 1 is provided with a receiving unit for switching between programs which are identical with each other and which are sent out via broadcast waves of different frequency bands in the broadcast areas of different sending-out stations to receive one of the programs, and also is provided with a storage unit and a control unit. A history of switching between frequency bands for each program received by the receiving unit is stored in this storage unit. The control unit controls the switching process of, when a moving object in which this broadcast receiver is mounted moves between the broadcast areas of two sending-out station which send out an identical program via broadcast waves of different frequency bands respectively, switching between the frequency bands on the basis of a history of switching between the frequency bands for the program which is read from the above-mentioned storage unit, the switching process being carried out by the above-mentioned receiving unit. With this configuration, the above-mentioned conventional broadcast receiver can shorten the length of time required to receive again, in the broadcast area to which the moving object has moved, the same program as the program which the conventional broadcast receiver was receiving in the broadcast area from which the moving object has moved.
[Patent reference 1] JP, 2007-129389, A

The above-mentioned conventional broadcast receiver has switched between the frequency bands of the broadcast waves of a program which the conventional broadcast receiver should receive according to the frequency with which the conventional broadcast receiver has performed switching between the frequency bands, the frequency being determined from the above-mentioned switching history. A problem is therefore that because the conventional broadcast receiver switches between frequency bands in consideration of only a history of past reception states in that way, the conventional broadcast receiver may switch between the frequency bands of broadcast waves improperly even in a case in which the current reception state does not match any reception state recorded in the history.

The above-mentioned conventional broadcast receiver does not take into consideration a state in which the switching between the frequency bands of broadcast waves which the conventional broadcast receiver should receive is repeated frequently when the moving object is existing between their broadcast areas, a so-called chattering state. A further problem is therefore that there is a possibility that even if the reception state recorded in the switching history is a chattering state, the switching is performed and the reception state gets worse after the switching has been performed.

The present invention is made in order to solve the above-mentioned problems, and it is therefore an object of the present invention to provide a broadcast receiver that can switch appropriately between the broadcast waves of an identical content sent out from different sending-out stations to receive one of the broadcast waves. It is another object of the present invention to provide a broadcast receiver that can prevent chattering from occurring in the above-mentioned switching.

### DISCLOSURE OF THE INVENTION

In accordance with the present invention, there is provided a broadcast receiver including: a receiving unit for receiving a broadcast wave sent out from a sending-out station; a position acquiring unit for acquiring position information about a position of a moving object in which the broadcast receiver is mounted; a broadcast display state acquiring unit for acquiring broadcast display state information showing a display state of the broadcast wave received by the receiving unit every time the moving object travels a distance; a storage unit for storing history information about switching between sending-out stations, the history information including the broadcast display state information, while bringing the history information into correspondence with the position information about the position of the moving object; an extracting unit for extracting history information from the storage unit; a determining unit for comparing current broadcast display state information acquired at a current position of the moving object with broadcast display state information in history information which is extracted from the storage unit by the extracting unit and which corresponds to a position which is same as the current position to determine that a sending-out station corresponding to history information which provides a display state which is same as a display state of a broadcast wave currently being received as the moving object travels is a switching destination; and a switching unit for changing the sending-out station from which to receive the broadcast wave by using the receiving unit according to a switching command from the determining unit. Because the broadcast receiver is configured in this way, there is provided an advantage of being able to appropriately switch between broadcast waves providing an identical content which are sent out from different sending-out stations to receive one of the broadcast waves.

### BRIEF DESCRIPTION OF THE FIGURES

FIG. 1 is a block diagram showing the configuration of a broadcast receiver in accordance with Embodiment 1 of the present invention;

FIG. 2 is a flow chart showing a flow of a process of judging a display state which is carried out by the broadcast receiver shown in FIG. 1; and

FIG. 3 is a flow chart showing a flow of a process of switching between stations which is carried out by the broadcast receiver shown in FIG. 1.

### PREFERRED EMBODIMENTS OF THE INVENTION

Hereafter, in order to explain this invention in greater detail, the preferred embodiments of the present invention will be described with reference to the accompanying drawings.

### Embodiment 1

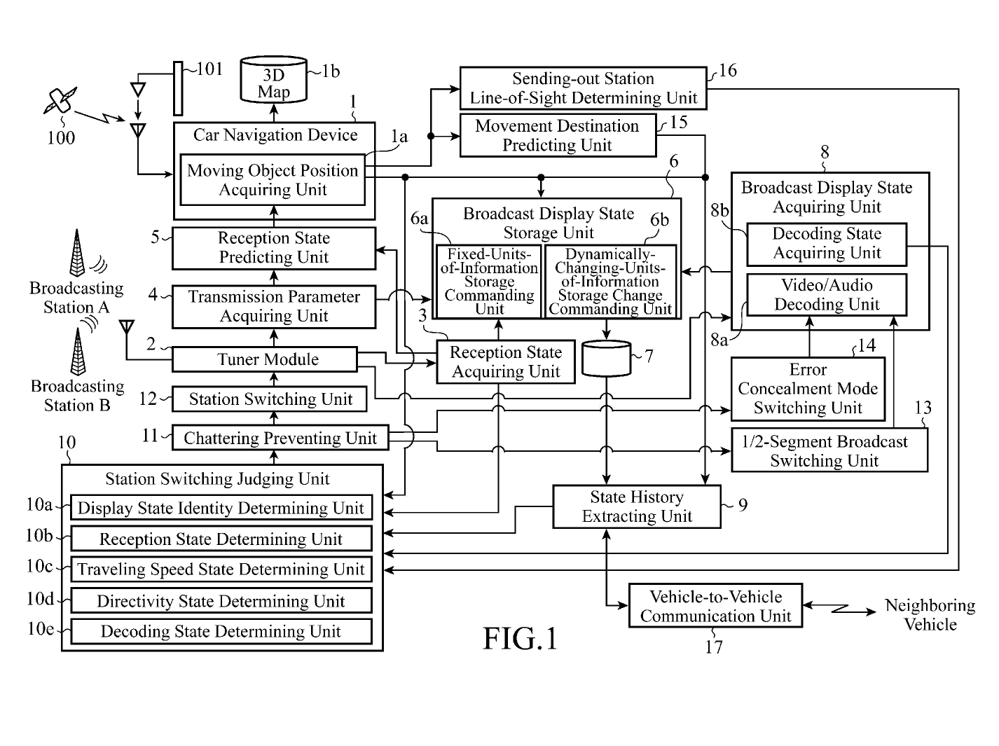

FIG. 1 is a block diagram showing the configuration of a broadcast receiver in accordance with Embodiment 1 of the present invention. When a vehicle equipped with the broadcast receiver shown in FIG. 1 (simply referred to as the vehicle from here on) moves across broadcast areas where an identical broadcast content is transmitted by using broadcast waves of different frequency bands, the broadcast receiver shown in FIG. 1 enables users to continuously view and listen to the identical broadcast content by changing the frequency band of the broadcast wave to be received. Next, components of the broadcast receiver in accordance with Embodiment 1 will be explained.

A car navigation device 1 shown in FIG. 1 is provided with a moving object position acquiring unit (a position acquiring unit) 1a. The car navigation device 1 analyzes 3D map data 1b on the basis of information about the current position of the vehicle acquired by this moving object position acquiring unit 1a to acquire information about the current position of the vehicle on a three-dimensional map shown by the 3D map data 1b.

The moving object position acquiring unit 1a acquires the information about the current position, the traveling direction, the speed, and the acceleration of the vehicle from GPS (Global Positioning System) satellites 100 or a light/radio wave beacon 101. The 3D map data 1b are three-dimensional map data in which information mainly including road information about roads, and also including information about buildings, mountains, and so on which are located around the roads is described. The 3D map data 1b are stored in a storage unit which can be read by the car navigation device 1 when needed.

A tuner module 2 receives a digital terrestrial broadcast wave via an antenna to acquire transmission parameters multiplexed into the broadcast wave.

These transmission parameters are set to the broadcast wave by a sending-out station which is a switching destination, and include, for example, a career modulation method, a convolutional coding rate, an interleaving length, and the number of segments. The tuner module 2 also receives a digital terrestrial broadcast wave via a plurality of antennas, and carries out diversity synthesis of the digital terrestrial broadcast wave. In this diversity synthesis process, the tuner module 2 acquires the field intensity of the broadcast wave yet-to-be-diversity-synthesized, an AGC (Auto Gain Control) parameter, the field intensity of the broadcast wave yet-to-be-AGC-synthesized, SNR (Signal Noise Rate) at the time before the diversity synthesis process is performed, and the number of corrected bits of an error correcting code.

A reception state acquiring unit 3 acquires information showing the reception state of the above-mentioned broadcast wave (either one or a combination of some of the field intensity of the broadcast wave yet-to-be-diversity-synthesized, an AGC (Auto Gain Control) parameter, the field intensity of the broadcast wave yet-to-be-AGC-synthesized, SNR (Signal Noise Rate) at the time before the diversity synthesis process is performed, the number of corrected bits of an error correcting code) from the tuner module 2. A transmission parameter acquiring unit 4 acquires the transmission parameters multiplexed into the received broadcast wave from the tuner module 2.

A reception state predicting unit 5 accepts the transmission parameters from the transmission parameter acquiring unit 4, also accepts the information showing the reception state of the above-mentioned broadcast wave from the reception state acquiring unit 3, and, when the data showing the reception state of the broadcast wave specified by those transmission parameters have a value equal to or smaller than a predetermined threshold, determines that the reception state further gets worse as the vehicle travels. For example, the data showing the reception state is a bit error rate for each career of the broadcast wave. In this case, the reception state predicting unit 5 determines the bit error rate every time when the vehicle travels a certain distance, compares the bit error rate with the predetermined threshold, and predicts a variation in the reception state which is caused by the travel of the vehicle on the basis of the comparison result.

A broadcast display state storage unit 6 is provided with a fixed-units-of-information storage commanding unit 6a and a dynamically-changing-units-of-information storage change commanding unit 6b, and stores history information about switching between sending-out stations including broadcast display state information in a storage device (a storage unit) 7. The broadcast display state information shows the display state of the broadcast wave received by the broadcast receiver in accordance with the present invention. Decoded data of audio and video included in the broadcast wave are taken as an example of the broadcast display state information.

Furthermore, the broadcast wave display state information is stored, as one history information, in the storage unit 7 together with the position information about the vehicle, the information showing the reception state of the above-mentioned broadcast wave, decoding state information, and the transmission parameters of the broadcast wave. The position information about the vehicle is acquired by the moving object position acquiring unit 1a, and is comprised of pieces of information respectively showing the current position, speed, acceleration, and traveling direction of the vehicle. As the decoding state information, error information about errors occurring in a decoding process of decoding the received data of the broadcast wave is provided. The sending-out station which is the switching destination can be specified by referring to the transmission parameters of the above-mentioned history information.

The fixed-units-of-information storage commanding unit (a storage commanding unit) 6a stores history information including broadcast display state information in the storage unit 7 in fixed units of information. For example, history information which is acquired for each of equal fixed-sized grid areas into which the map (the map shown by the 3D map data 1b) is divided is stored, as information which is a fixed unit of information, in the storage unit 7. Furthermore, history information which is acquired for each fixed distance along the road along which the vehicle is travelling on the map is stored, as information which is a fixed unit of information, in the storage unit 7.

The dynamically-changing-units-of-information storage change commanding unit (a storage unit changing unit) 6b extracts history information which has not been updated or read for a predetermined time period or longer (i.e. history information which is acquired at a position which the vehicle has not visited for the predetermined time period or longer) from among the history information stored in the storage unit 7 to change the units of information to be stored in the storage unit 7. For example, according to the frequency with which the history information is updated or read, the dynamically-changing-units-of-information storage change commanding unit 6b merges a grid area or a road region having a fixed distance where this history information has been acquired with a neighboring grid area or a neighboring road region, and stores, as history information acquired in the merged area or merged road, the history information about the grid areas or road regions in the storage unit 7.

A broadcast display state acquiring unit 8 outputs broadcast display state information consisting of played-back data of the broadcast data received by the tuner module 2 to the broadcast display state storage unit 6. The broadcast display state acquiring unit 8 also outputs, as decoding state information, information about errors occurring in the process of playing back the broadcast data to the broadcast display state storage unit 6.

A video/audio decoding unit (a playback unit) 8a is a component of the broadcast display state acquiring unit 8, and decodes the broadcast data received by the tuner module 2 to acquire video data and audio data. The video/audio decoding unit 8a plays back subtitles, superimposed characters or the like in addition to the video and the audio showing the broadcast content. A decoding state acquiring unit (an error information acquiring unit) 8b is a component of the broadcast display state acquiring unit 8, and acquires error information about errors occurring in the decoding process carried out by the video/audio decoding unit 8a.

In a case in which MPEG data is played back, the error information includes the number of TS packets in each of which an error indicator is set in a TS (Transport Stream) acquired in a TS-DeMUX process, the number of counted CRC (Cyclic Redundancy Check) errors which are checked at the time of a section assembly, the number of decoding errors occurring in the video decode (Video Decode) process, the number of decoding errors occurring in the audio decode (Audio Decode) process, the number of breaks occurring in a data signal which is a serial audio output from an audio decoder, and the time interval during which each of the breaks has occurred.

A state history extracting unit (an extracting unit) 9 reads the history information corresponding to the current vehicle position acquired by the moving object position acquiring unit 1a from the storage unit 7, and outputs the history information to a station switching judging unit 10. Furthermore, when the history information corresponding to the above-mentioned current vehicle position is not stored in the storage unit 7, the state history extracting unit 9 reads history information corresponding to a position at a predetermined distance from the above-mentioned current vehicle position from the storage unit 7. In addition, when any broadcast display state information corresponding to the neighboring grid area is not stored, the state history extracting unit 9 outputs history information which is acquired by a vehicle-to-vehicle communication unit 17 and which is set to the broadcast receiver of another vehicle currently traveling in the neighborhood of the vehicle to the station switching judging unit 10.

The station switching judging unit (a determining unit) 10 judges whether or not to receive the broadcast wave from which one of the sending-out stations transmitting the broadcast waves to the broadcast receiver (in the example shown in FIG. 1, one of the sending-out stations A and B) by using the history information acquired by the state history extracting unit 9. This station switching judging unit 10 is provided with a display state identity determining unit 10a, a reception state determining unit 10b, a traveling speed state determining unit 10c, a directivity state determining unit 10d, and a decoding state determining unit 10e.

The display state identity determining unit 10a determines whether or not the broadcast display state has been varying in the same way that a corresponding past broadcast display state had been varying until the vehicle reaches the current position on the basis of the result of the comparison between the current broadcast display state information corresponding to the vehicle position and past broadcast display state information corresponding to the current position of the vehicle which is acquired by the state history extracting unit 9.

When the reception state determining unit 10b cannot acquire the history information from the state history extracting unit 9, the reception state determining unit 10b compares a parameter value showing the reception state acquired by the reception state acquiring unit 3 with the predetermined threshold to determine the reception state of the broadcast wave according to this comparison result. In contrast, when the reception state determining unit 10b can acquire the history information from the state history extracting unit 9, the reception state determining unit 10b determines the reception state of the broadcast wave with reference to this history information.

The history information extracted from the state history extracting unit 9 to the reception state determining unit 10b can be history information corresponding to the predicted position of the vehicle determined by, for example, a movement destination predicting unit 15. Furthermore, when no history information corresponding to the above-mentioned predicted position is stored in the storage unit 7, history information corresponding to a position which is the nearest to this predicted position is read from the storage unit 7 by the state history extracting unit 9, and is outputted to the reception state determining unit 10b.

The traveling speed state determining unit 10c extracts speed information about the vehicle from the history information acquired by the state history extracting unit 9 to determine whether or not the amount of noise occurring in the current receiving environment according to the result of comparison between this speed information and the current vehicle speed is large. For example, when the current vehicle speed is higher than a pastly-determined speed at the same position, the traveling speed state determining unit determines that the amount of current noise is larger than a past one, whereas when the current vehicle speed is lower than the pastly-determined speed at the same position, the traveling speed state determining unit determines that the amount of current noise is smaller than the past one.

The directivity state determining unit 10d extracts information showing the traveling direction of the vehicle from the history information acquired by the state history extracting unit 9 to determine whether or not to use this history information for judgment of whether to carry out switching between stations according to the result of comparison between this traveling direction and the current traveling direction of the vehicle. For example, when the traveling direction of the vehicle extracted from the history information matches the current traveling direction of the vehicle, the directivity state determining unit carries out the judgment of whether to carry out switching between stations with reference to this history information, whereas when the traveling direction of the vehicle extracted from the history information does not match the current traveling direction of the vehicle, the directivity state determining unit carries out the judgment of whether to carry out the switching between stations without reference to the history information.

When the state history extracting unit 9 cannot acquire the history information (when the history information is not stored in the storage unit 7), the decoding state determining unit 10e acquires decoding state information from the decoding state acquiring unit 8b to determine whether or not to perform the switching between sending-out stations according to the result of comparison between a parameter value which constructs this decoding state information and a predetermined threshold. In contrast, when the decoding state determining unit 10e can acquire the history information via the state history extracting unit 9, the decoding state determining unit determines whether or not to perform the switching between sending-out stations with reference to the decoding state information included in this history information.

When the station switching judging unit 10 has outputted a station switching command continuously at time intervals shorter than predetermined time intervals, a chattering preventing unit 11 determines that the vehicle has been being located between the broadcast areas of sending-out stations A and B neighboring to each other, and the reception state of receiving the broadcast waves from them is a chattering state, and then transmits the newest station switching command to a station switching unit 12 after a fixed time has elapsed. The station switching unit 12 accepts the station switching command from the station switching judging unit 10 through the chattering determination by the chattering preventing unit 11, and sets transmission parameters for receiving the broadcast wave of the sending-out station specified by this station switching command to the tuner module 2.

A 1/12-segment broadcasting switching unit 13 receives a 1/12-segment broadcasting switching command from the chattering preventing unit 11, and sets decode parameters according to 1/12-segment broadcasting to the video/audio decoding unit 8a. An error concealment mode switching unit 14 switches the video/audio decoding unit 8a to an error concealment mode according to a command from the chattering preventing unit 11. When switched to the error concealment mode, the video/audio decoding unit 8a carries out error concealment after the decoding process is performed.

The movement destination predicting unit 15 predicts the position of the movement destination of the vehicle on the basis of the information showing the speed or acceleration of the vehicle acquired by the moving object position acquiring unit 1a. For example, when determining that the vehicle is traveling at a high speed or suddenly accelerating from the information showing the current speed or acceleration of the vehicle, the movement destination predicting unit 15 judges that the vehicle will not change its traveling direction rapidly, and then predicts the vehicle position at the destination to which the vehicle will move from the current position in the current traveling direction. The movement destination predicting unit determines, as the vehicle position at the movement destination, a position on a three-dimensional map shown by the 3D map data 1b.

A sending-out station line-of-sight determining unit (a line-of-sight determining unit) 16 determines whether or not the broadcast wave from a sending-out station has a line-of-sight path between the current position of the vehicle and the sending-out station. For example, when acquiring the current position information about the vehicle (the current position, traveling direction, and speed of the vehicle) from the moving object position acquiring unit 1a, the sending-out station line-of-sight determining unit 16 receives the three-dimensional map information including the vehicle position and the position of a sending-out station from the car navigation device 1. The sending-out station line-of-sight determining unit 16 determines whether or not the broadcast wave from the above-mentioned sending-out station is in a line-of-sight state in which the broadcast wave has a line-of-sight path between the current position of the vehicle and the sending-out station, and how long the line-of-sight state will continue on the basis of these pieces of information inputted thereto, and informs them to the station switching judging unit 10.

A vehicle-to-vehicle communication unit (a moving-object-to-moving-object communication unit) 17 carries out bidirectional communications between the broadcast receiver in accordance with this Embodiment 1 and another broadcast receiver in accordance with this Embodiment 1 which is mounted in another vehicle traveling in the neighborhood. For example, the vehicle-to-vehicle communication unit 17 acquires history information set to the broadcast receiver of the above-mentioned other vehicle by carrying out bidirectional communications with the vehicle-to-vehicle communication unit 17 of the broadcast receiver mounted in the above-mentioned other vehicle.

Next, the operation of the broadcast receiver will be explained.

First, the moving object position acquiring unit 1a of the car navigation device 1 acquires the position information about the vehicle from, for example, the GPS satellites 100, the light/radio wave beacon 101 from a sending-out device installed in a road or the like, an acceleration sensor or a three-dimensional gyroscope mounted in the car navigation device 1, or a base station for mobile phones. The moving object position acquiring unit acquires, as the position information about the vehicle, the current position (a current position on a three-dimensional map shown by the 3D map data 1b), traveling direction, speed, and acceleration of the vehicle.

The tuner module 2 receives a digital broadcasting wave sent out from a sending-out station A or B via the antenna. The reception state acquiring unit 3 acquires information showing the reception state of the above-mentioned digital broadcast wave (either one or a combination of some of the field intensities of the broadcast wave yet-to-be-diversity-synthesized, an AGC parameter, the field intensity of the broadcast wave yet-to-be-AGC-synthesized, SNR at the time before the diversity synthesis process is carried out, the number of corrected bits of an error correcting code) from the tuner module 2. The reception state acquiring unit transfers the information showing the reception state acquired from the tuner module 2 to the reception state predicting unit 5 and the broadcast display state storage unit 6.

The transmission parameter acquiring unit 4 controls the tuner module 2 to cause the tuner module to separate the transmission parameter multiplexed into the above-mentioned digital broadcasting wave, and acquires this transmission parameter from the tuner module 2. The transmission parameter acquiring unit 4 transfers the transmission parameter acquired from the tuner module 2 to the reception state predicting unit 5 and the broadcast display state storage unit 6.

The digital broadcasting data received by the tuner module 2 are also sent to the broadcast display state acquiring unit 8. The video/audio decoding unit 8a of the broadcast display state acquiring unit 8 decodes the digital broadcasting data inputted thereto from the tuner module 2 to reproduce video or audio data, and transfers them to the broadcast display state storage unit 6. On the other hand, the decoding state acquiring unit 8b of the broadcast display state acquiring unit 8 acquires error information about decoding errors occurring during the decoding process carried out by the video/audio decoding unit 8a, and transfers the error information to the broadcast display state storage unit 6.

The broadcast display state storage unit 6 stores the transmission parameter inputted from the transmission parameter acquiring unit 4, the information showing the reception state inputted from the reception state acquiring unit 3, and the broadcast display state information and the decoding state information inputted from the broadcast display state acquiring unit 8 in the storage unit 7 while bringing them into correspondence the current position information about the vehicle inputted from the moving object position acquiring unit 1a. To be more specific, the fixed-units-of-information storage commanding unit 6a of the broadcast display state storage unit 6 stores, as one history information, the above-mentioned position information about the vehicle, the above-mentioned transmission parameter, the information showing the above-mentioned reception state, and the broadcast display state information and the above-mentioned decoding state information in the storage unit 7 in certain fixed units of information corresponding to the vehicle position. As these fixed units of information, there can be considered either equal fixed-sized grid areas (divided units) into which the map (the map shown by the 3D map data 1b) is divided, or predetermined distance units of a road on the map.

The dynamically-changing-units-of-information storage change commanding unit 6b of the broadcast display state storage unit 6 always monitors access to the storage unit 7 to determine whether an update or reading has been performed on the history information stored in fixed units of information in the storage unit 7 within a predetermined time period. When there is a fixed unit of information on which any update or reading has not been performed for the predetermined time period or longer among the history information stored in fixed units of information in the storage unit 7, the dynamically-changing-units-of-information storage change commanding unit 6b carries out a process of merging this fixed unit of information in the history information on which any update or reading has not been performed for the predetermined time period or longer with a neighboring fixed unit of information on the map to change them into a new storage unit of information.

For example, in the case in which the fixed units of information are equal fixed-sized grid areas into which the map is divided, the dynamically-changing-units-of-information storage change commanding unit 6b merges a grid area for which history information has been acquired with a neighboring grid area according to the frequency with which the history information has been updated or read, and stores, as history information acquired for the merged areas, the pieces of history information of the areas in the storage unit 7. In contrast, in the case in which the fixed units of information are predetermined distance units of a road on the map, the dynamically-changing-units-of-information storage change commanding unit 6b merges a road region of a predetermined distance for which history information has been acquired with a neighboring road region, and stores, as history information acquired for the merged road regions, the pieces of history information of the road regions in the storage unit 7.

While the vehicle is moving, the state history extracting unit 9 sequentially receives the current position information about the vehicle from the moving object position acquiring unit 1a. The state history extracting unit 9 searches through the memory contents of the storage unit 7 on the basis of the current position information about the vehicle inputted from the moving object position acquiring unit 1a to acquire the history information corresponding to the current position of the vehicle from the storage unit 7, and outputs the history information to the station switching judging unit 10.

When there is no history information corresponding to the current position of the vehicle in the storage unit 7, the state history extracting unit 9 reads history information corresponding to a position at a predetermined distance from the current position of the vehicle from the storage unit 7, and outputs the history information to the station switching judging unit 10. In this case, because the change tendency of the broadcast display state or the reception state when the vehicle moves to a position close to the current position can be determined, the time of the switching between sending-out stations can be predicted.

In addition, when there is no history information corresponding to a position at the predetermined distance from the current position of the vehicle in the storage unit 7, the state history extracting unit 9 outputs the history information which is acquired from the broadcast receiver of another vehicle traveling in the neighborhood by the vehicle-to-vehicle communication unit 17 to the station switching judging unit 10. The vehicle-to-vehicle communication unit 17 acquires the history information which is currently being referred to for judgment of whether or not to perform switching between stations by the broadcast receiver of the other vehicle traveling in the neighborhood from the other broadcast receiver.

Furthermore, the station switching judging unit 10 receives, as the information showing the current broadcast display state and so on, the information showing the current reception state from the reception state acquiring unit 3, the current broadcast display state information from the video/audio decoding unit 8a, the current decoding state information from the decoding state acquiring unit 8b, and the current position information about the vehicle (the current position, traveling speed, moving azimuth, and so on of the vehicle) from the moving object position acquiring unit 1a. After that, the station switching judging unit 10 judges whether or not to change the sending-out station from which the broadcast receiver should receive the broadcast wave according to the results of the determinations by the determining units 10a to 10e which will be mentioned below.

(1) The Determining Process Carried Out by the Display State Identity Determining Unit 10a

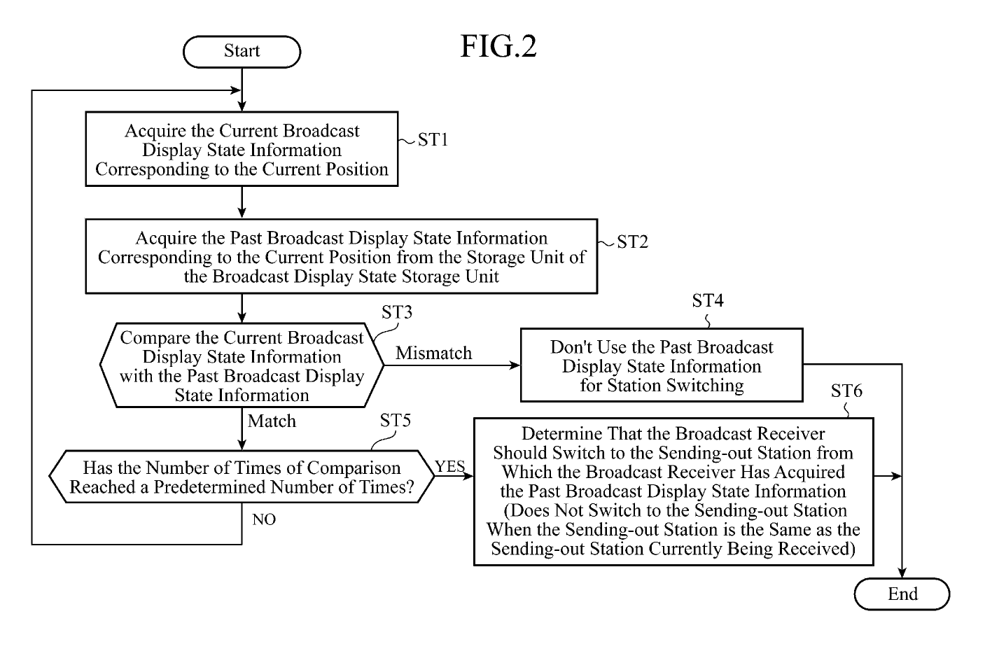

FIG. 2 is a flow chart showing a flow of the station switching determining process carried out by the display state identity determining unit shown in FIG. 1. In an example shown in FIG. 2, the display state identity determining unit 10a determines whether or not to perform the switching between stations by using the history information corresponding to the current position acquired by the state history extracting unit 9. The history information includes the information showing the reception state, the decoded data of the video and audio (the broadcast display state information), the decoding state information showing the error information about errors occurring in the decoding, the transmission parameter, and the position information about the current position, speed, acceleration, traveling direction, and so on of the vehicle acquired from the moving object position acquiring unit 1a.

First, the display state identity determining unit 10a receives the information showing the current reception state from the reception state acquiring unit 3, the current broadcast display state information from the video/audio decoding unit 8a, the decoding state information about the current received data from the decoding state acquiring unit 8b, and the current position information about the vehicle from the moving object position acquiring unit 1a (step ST1). Thus, the pieces of information inputted in real time are acquired by the display state identity determining unit 10a as information including the current broadcast display state information.

Next, the display state identity determining unit 10a receives the history information including the past broadcast display state information corresponding to the current position which has been read from the storage unit 7 by the state history extracting unit 9 (step ST2). The display state identity determining unit 10a then compares the information including the above-mentioned current broadcast display state information with the above-mentioned history information including the past broadcast display state information corresponding to the current position to determine whether or not the current broadcast display state information matches the past broadcast display state information (step ST3). In this determination, not only in a case in which data which constructs the current broadcast display state information fully match data which constructs the past broadcast display state information, but also in a case in which the difference between the above-mentioned current broadcast display state information and the above-mentioned past broadcast display state information falls with a predetermined permissible range, it is determined that the current broadcast display state information matches the past broadcast display state information.

When, in step ST3, determining the current broadcast display state information does not match the past broadcast display state information, the display state identity determining unit 10a does not refer to the above-mentioned history information corresponding to the current position in the station switching determination (step ST4). When it is determined that the current broadcast display state information does not match the past broadcast display state information, it can be considered that the current broadcast display state and the past broadcast display state do not vary in the same way as the vehicle travels. In this case, it is considered that the history information including the above-mentioned past broadcast display state information does not have data credibility which is sufficient to show that the history information is handled as information showing the broadcast display state of the broadcast receiver which has been varied until the vehicle reaches the current position. Therefore, the display state identity determining unit 10a determines whether or not to switch to another sending-out station corresponding to history information other than this history information, or determines that the broadcast receiver should keep the reception of the broadcast wave from the currently-selected sending-out station.

In contrast, when determining that the current broadcast display state information matches the past broadcast display state information, the display state identity determining unit 10a determines whether the number of times that it has carried out the comparison reaches a predetermined number of times which is set in advance (step ST5). When the number of times that the display state identity determining unit 10a has carried out the comparison does not reach the predetermined number of times, the display state identity determining unit 10a returns to the process of step ST1 and repeats the above-mentioned process until the number of times that the display state identity determining unit has carried out the comparison reaches the predetermined number of times.

When the current broadcast display state information matches the past broadcast display state information before the number of times that the display state identity determining unit has carried out the comparison reaches the predetermined number of times, the display state identity determining unit 10a determines that the broadcast receiver should change the sending-out station from which the broadcast receiver should receive the broadcast wave to a sending-out station for which the broadcast receiver has acquired the history information including the above-mentioned past broadcast display state information (step ST6). When the sending-out station for which the broadcast receiver has acquired this history information is the same as that from which the broadcast receiver is currently receiving the broadcast wave, the display state identity determining unit 10a determines that the broadcast receiver should keep the reception of the broadcast wave from this sending-out station. Thus, when the current broadcast display state information has matched the past broadcast display state information for a predetermined time period, the display state identity determining unit determines that the current broadcast display state and the past broadcast display state have varied in the same way when the vehicle has traveled. In this case, it is considered that the history information including the above-mentioned past broadcast display state information has data credibility which is sufficient to show that the history information is handled as information showing the broadcast display state of the broadcast receiver which has been varied until the vehicle reaches the current position. Therefore, the display state identity determining unit 10a determines whether or not to perform the switching between stations with reference to this history information.

(2) The Determining Process Carried Out by the Reception State Determining Unit 10b

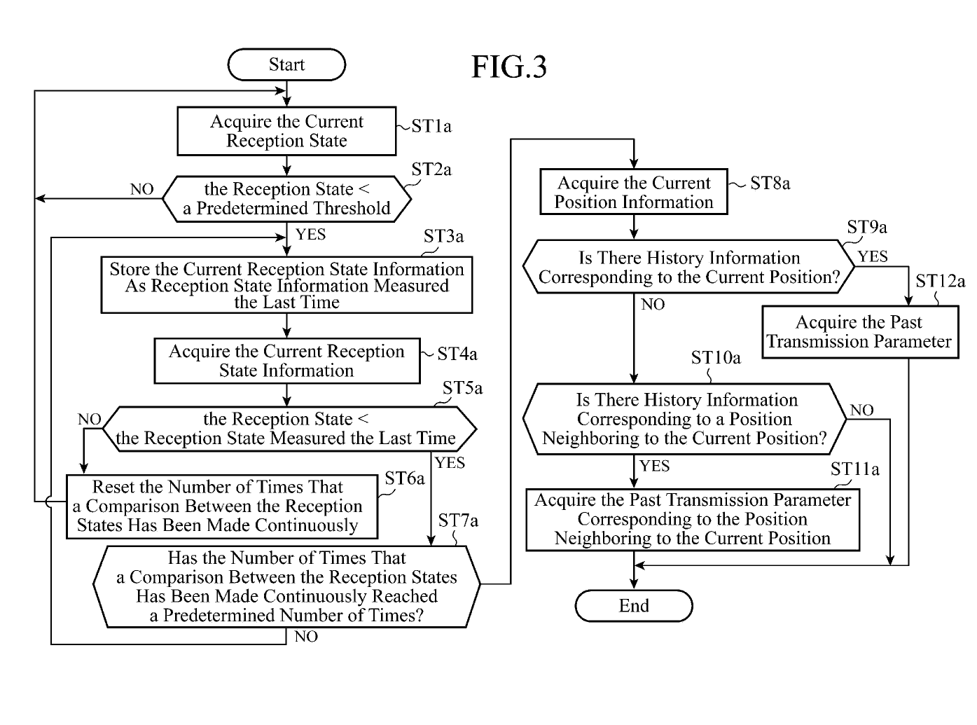

FIG. 3 is a flow chart showing a flow of the process of determining whether or not to perform the switching between stations which is carried out by the reception state determining unit shown in FIG. 1. In an example shown in FIG. 3, the reception state determining unit 10b determines whether or not to perform the switching between stations by using the information showing the reception state among the history information. First, the reception state determining unit 10b receives a parameter showing the current reception state acquired by the reception state acquiring unit 3 (step ST1a).

Next, the reception state determining unit 10b compares the parameter value showing the above-mentioned reception state with a predetermined threshold to determine whether or not the parameter value is larger than the predetermined threshold (step ST2a). As the parameter showing the reception state, for example, there can be mentioned either one or a combination of some of the field intensity of the broadcast wave yet-to-be-diversity-synthesized, an AGC parameter, the field intensity of the broadcast wave yet-to-be-AGC-synthesized, SNR at the time before the diversity synthesis process is carried out, the number of corrected bits of an error correcting code. Furthermore, as the above-mentioned predetermined threshold, a lower limit that provides a standard reception state for the above-mentioned parameter is set up.

When, in step ST2a, the parameter value showing the above-mentioned reception state is larger than the above-mentioned predetermined threshold, the reception state determining unit 10b returns to the process of step ST1a. In this case, because the reception state is good, the reception state determining unit determines that the broadcast receiver should keep the reception of the broadcast wave from the currently-selected sending-out station.

In contrast, when the parameter value showing the above-mentioned reception state is smaller than the above-mentioned predetermined threshold, the reception state determining unit 10b stores, as a parameter used for comparison with a parameter showing a newly-acquired reception state (i.e., as a parameter showing the reception state which was measured the last time), the parameter showing the above-mentioned reception state (step ST3a). Thus, when the parameter value showing the reception state is smaller than the above-mentioned predetermined threshold, it is predicted that the reception state of the broadcast wave will get worse from now on. In this case, the reception state determining unit 10b analyzes the change tendency of the reception state of the broadcast wave by doing in such a way as will be mentioned below.

The reception state determining unit 10b, in step ST4a, receives the parameter showing the reception state which is newly acquired by the reception state acquiring unit 3. After that, the reception state determining unit 10b compares the parameter value showing the newly-acquired reception state with the parameter value showing the reception state which was measured the last time to determine whether or not the parameter value showing the newly-acquired reception state is larger than the parameter value showing the reception state which was measured the last time (step ST5a). When the parameter value showing the newly-acquired reception state is larger than the parameter value showing the reception state which was measured the last time, the reception state determining unit 10b resets the number of times that the reception state determining unit has compared the parameter value showing the newly-acquired reception state with the parameter value showing the reception state which was measured the last time continuously (step ST6a), and returns to the process of step ST1a.

In contrast, when the parameter value showing the newly-acquired reception state is smaller than the parameter value showing the reception state which was measured the last time, the reception state determining unit determines whether or not the number of times that the reception state determining unit has made the comparison between the newly-acquired reception state and the previous reception state reaches a predetermined number of times (step ST7a). Unless the number of times that the reception state determining unit has made the comparison between the newly-acquired reception state and the previous reception state reaches the predetermined number of times, the reception state determining unit 10b returns to the process of step ST3a and repeats the process of making the comparison between the newly-acquired reception state and the previous reception state. The change tendency of the reception state is thus analyzed by the reception state determining unit 10b.

In contrast, if the state in which the parameter value showing the newly-acquired reception state is smaller than the parameter value showing the reception state which was measured the last time continues (a tendency for the reception state to get worse continues) until the number of times that the reception state determining unit has made the comparison between the newly-acquired reception state and the previous reception state reaches the predetermined number of times, the reception state determining unit 10b determines that the broadcast receive should switch from the sending-out station from which it is currently receiving the broadcast wave to another sending-out station, and then acquires the current position information about the vehicle from the moving object position acquiring unit 1a (step ST8a). After that, the reception state determining unit 10b controls the state history extracting unit 9 to cause the state history extracting unit to search through the memory contents of the storage unit 7 on the basis of the current position information about the vehicle for the history information corresponding to the current position of the vehicle (step ST9a).

In this case, when the history information corresponding to the above-mentioned current position of the vehicle is not stored in the storage unit 7, the reception state determining unit 10b controls the state history extracting unit 9 to cause the state history extracting unit to search through the memory contents of the storage unit 7 for history information corresponding to a position in the neighboring at a predetermined distance from the current position of the vehicle (step ST10a). At this time, when there is history information corresponding to the above-mentioned neighboring position, the reception state determining unit 10b acquires this history information via the state history extracting unit 9. After that, the reception state determining unit 10b extracts the transmission parameter from this history information, and outputs it, as well as a station switching command, to the station switching unit 12 via the chattering preventing unit 11 (step ST11a).

When, in step ST9a, the history information corresponding to the current position of the vehicle is stored in the storage unit 7, the reception state determining unit 10b acquires this history information via the state history extracting unit 9. After that, the reception state determining unit 10b extracts the transmission parameter from this history information, and outputs it, as well as a station switching command, to the station switching unit 12 via the chattering preventing unit (step ST12a).

(3) The Determining Process Carried Out by the Decoding State Determining Unit 10e

First, the decoding state determining unit 10e accepts current decoding state information acquired by the decoding state acquiring unit 8b. Next, the decoding state determining unit 10e compares the above-mentioned decoding state information with a predetermined threshold. As the decoding state information which is compared with the above-mentioned threshold, there can be considered a decoding error frequency. For example, when MPEG data is played back, the decoding error frequency can be the number of TS packets in each of which an error indicator is set, the number of CRC errors, the number of decoding errors occurring in the video decoding process, the number of decoding errors occurring in the audio decoding process, the number of breaks occurring in a data signal which is a serial audio output from an audio decoder, or the time interval during which each of the breaks has occurred. As the above-mentioned predetermined threshold, an acceptable value regarding the above-mentioned error frequency can be mentioned.

When the error frequency is less than the above-mentioned predetermined threshold, the decoding state determining unit 10e determines that the broadcast receiver should keep the reception of the broadcast wave from the currently-selected sending-out station because the decoding state is good. In contrast, when the decoding state information has a value which is greater than the above-mentioned predetermined threshold, the decoding state determining unit 10e stores the current decoding state information as a parameter to be compared with newly-acquired decoding state information (i.e., as the decoding state information which was acquired the last time). Thus, when the decoding state information has a value which is less than the above-mentioned predetermined threshold, it can be predicted that the decoding state of the broadcast wave will get worse from now on. In this case, the decoding state determining unit 10e analyzes the change tendency of the decoding state of the broadcast wave by doing in such a way as will be mentioned below.

The decoding state determining unit 10e then accepts decoding state information newly acquired by the decoding state acquiring unit 8b. After that, the decoding state determining unit 10e compares the newly-acquired decoding state information with the decoding state information which was acquired the last time to determine whether or not the value of the newly-acquired decoding state information is larger than that of the decoding state information which was acquired the last time. When the value of the newly-acquired decoding state information is smaller than that of the decoding state information which was acquired the last time, the decoding state determining unit 10e resets the number of times that the decoding state determining unit has compared the newly-acquired decoding state information with the decoding state information which was acquired the last time continuously, and returns to the acquisition process of acquiring decoding state information to be compared with the above-mentioned predetermined threshold.

In contrast, when the value of the newly-acquired decoding state information is larger than that of the decoding state information which was acquired the last time, the decoding state determining unit 10e determines whether or not the number of times that the decoding state determining unit has compared the newly-acquired decoding state information with the decoding state information which was acquired the last time continuously reaches a predetermined number of times. Unless the number of times that the decoding state determining unit has compared the newly-acquired decoding state information with the decoding state information which was acquired the last time continuously reaches the predetermined number of times, the decoding state determining unit 10e repeats the comparison process of comparing the newly-acquired decoding state information with the previous decoding state information. Thus, the change tendency of the decoding state is analyzed by the decoding state determining unit 10e.

In contrast, if the state in which the value of the newly-acquired decoding state information (the error occurrence frequency) is larger than that of the decoding state information which was acquired the last time continues (a tendency for the reception state to get worse continues) until the number of times that the decoding state determining unit has made the comparison between the newly-acquired decoding state and the previous decoding state reaches the predetermined number of times, the decoding state determining unit 10e determines that the broadcast receive should switch from the sending-out station from which it is currently receiving the broadcast wave to another sending-out station, and then acquires the current position information about the vehicle from the moving object position acquiring unit 1a. After that, the decoding state determining unit 10e controls the state history extracting unit 9 to cause the state history extracting unit to search through the memory contents of the storage unit 7 on the basis of the current position information about the vehicle for the history information corresponding to the current position of the vehicle.

In this case, when the history information corresponding to the above-mentioned current position of the vehicle is not stored in the storage unit 7, the decoding state determining unit 10e controls the state history extracting unit 9 to cause the state history extracting unit to search through the memory contents of the storage unit 7 for history information corresponding to a position in the neighboring at a predetermined distance from the current position of the vehicle. At this time, when there is history information corresponding to the above-mentioned neighboring position, the decoding state determining unit 10e acquires this history information via the state history extracting unit 9. After that, the decoding state determining unit 10e extracts the transmission parameter from this history information, and outputs it, as well as a station switching command, to the station switching unit 12 via the chattering preventing unit 11.

When the history information corresponding to the current position of the vehicle is stored in the storage unit 7, the decoding state determining unit 10e acquires this history information via the state history extracting unit 9. After that, the decoding state determining unit 10e extracts the transmission parameter from this history information, and outputs it, as well as a station switching command, to the station switching unit 12 via the chattering preventing unit 11.

(4) The Determining Process Carried Out by the Traveling Speed State Determining Unit 10c

The traveling speed state determining unit 10c accepts the current position information about the vehicle from the moving object position acquiring unit 1a, and extracts the current speed information about the vehicle from this position information. The traveling speed state determining unit 10c also accepts the history information corresponding to the current position of the vehicle which is acquired by the state history extracting unit 9, and extracts the speed information about the vehicle from this history information.

Next, the traveling speed state determining unit 10c compares the current speed information with the past speed information which is extracted from the history information, and, when the current speed of the vehicle is higher than the past speed at the same position, and determines that the current receiving environment has a larger amount of noise, whereas when the current speed of the vehicle is lower than the past speed at the same position, and the traveling speed state determining unit determines that the current receiving environment has a smaller amount of noise. This determination result, as well as the determination results obtained by the above-mentioned display state identity determining unit 10a, the above-mentioned reception state determining unit 10b, and the above-mentioned decoding state determining unit 10e, are referred to by the station switching judging unit 10 when making a final decision as to whether or not to carry out the switching between stations.

(5) The Determining Process Carried Out by the Directivity State Determining Unit 10d

The directivity state determining unit 10d accepts the current position information about the vehicle from the moving object position acquiring unit 1a, and extracts the information about the current traveling direction of the vehicle from this position information. The directivity state determining unit 10d accepts the history information corresponding to the current position of the vehicle which is acquired by the state history extracting unit 9, and extracts the information about the traveling direction of the vehicle from this history information.

Next, the directivity state determining unit 10d compares the current traveling direction of the vehicle with the past traveling direction which is extracted from the history information, and, when the traveling direction of the vehicle extracted from the above-mentioned history information matches the current traveling direction of the vehicle, determines this history information as information to be referred to when making a decision as to whether or not to carry out the switching between stations, whereas when the traveling direction of the vehicle extracted from the above-mentioned history information does not match the current traveling direction of the vehicle, the directivity state determining unit determines the history information as information not to be referred to when making a decision as to whether or not to carry out the switching between stations. This determination result, as well as the determination results obtained by the above-mentioned display state identity determining unit 10a, the above-mentioned reception state determining unit 10b, the above-mentioned traveling speed state determining unit 10c, and the above-mentioned decoding state determining unit 10e, are referred to by the station switching judging unit 10 when making a final decision as to whether or not to carry out the switching between stations.

The station switching judging unit 10 refers to the determination results obtained by the display state identity determining unit 10a, the reception state determining unit 10b, the traveling speed state determining unit 10c, the directivity state determining unit 10d, and the decoding state determining unit 10e to make a final decision as to whether or not to carry out the switching between stations. When changing the sending-out station from which to receive the broadcast wave, the station switching judging unit 10 outputs station switching command information including the transmission parameter for receiving the broadcast wave sent out from the sending-out station which is the switching destination to the chattering preventing unit 11.

When receiving the station switching command information from the station switching judging unit 10, the chattering preventing unit 11 records this station switching command information and its reception time, and also determines whether or not the time interval between this reception time and the previous reception time is shorter than a predetermined time interval. When the time interval between this reception time and the previous reception time is longer than the predetermined time interval, the chattering preventing unit 11 outputs the station switching command information to the station switching unit 12.

In contrast, when the time interval between this reception time and the previous reception time is shorter than the above-mentioned predetermined time interval, the chattering preventing unit 11 does not output the station switching command information to the station switching unit 12, but makes a transition to a waiting state until the above-mentioned predetermined time interval elapses. After this predetermined time interval has elapsed, the chattering preventing unit 11 outputs the newest station switching command information which is inputted thereto by the time the above-mentioned predetermined time interval has elapsed to the station switching unit 12.

When receiving the station switching command information from the chattering preventing unit 11, the station switching unit 12 extracts the transmission parameter for receiving the broadcast wave of the sending-out station which is the switching destination from this station switching specification information, and sets the transmission parameter to the tuner module 2. As a result, the broadcast receiver in accordance with this Embodiment 1 can switch from the sending-out station covering the broadcast area from which the vehicle has moved to the other sending-out station covering the broadcast area to which the vehicle has moved to receive the broadcast wave providing the same broadcast content.

Furthermore, the chattering preventing unit 11 records an output time when it outputs the station switching command information to the station switching unit 12. When the switching between sending-out stations is carried out within a predetermined time period since the above-mentioned output time, and the station switching command information is inputted frequently, the chattering preventing unit 11 determines that, even if it receives the broadcast wave from either of the sending-out station which is the switching destination and the other sending-out station which is the switching source, the reception state of the broadcast wave is bad. At this time, the chattering preventing unit 11 notifies the station switching judging unit 10 to that effect. The station switching judging unit 10 determines, as a new switching destination, a sending-out station according to this notification.

In addition, when the reception state of the broadcast wave is bad, the chattering preventing unit 11 can carry out broadcast switching to receive a 1/12-segment broadcast. In this case, the chattering preventing unit 11 outputs a transmission parameter for receiving the broadcast wave of the 1/12-segment broadcasting to the station switching unit 12 to command the 1/12-segment broadcasting switching unit 13 to change the decode parameters of the video/audio decoding unit 8a into parameters according to the 1/12-segment broadcasting.

The station switching unit 12 sets the transmission parameter for receiving the broadcast wave of the 1/12-segment broadcasting to the tuner module 2. When receiving the 1/12-segment broadcasting switching command from the chattering preventing unit 11, the 1/12-segment broadcasting switching unit 13 sets the decode parameters according to 1/12-segment broadcasting to the video/audio decoding unit 8a. As a result, reception of the 1/12-segment broadcasting is started.

When the 1/12-segment broadcasting is simultaneous broadcasting, the station switching unit 12 sets the transmission parameter for receiving a desired broadcast among broadcasts providing the same content transmitted via the simultaneous broadcasting to the tuner module 2. As a result, the broadcast transmitted via the desired channel is received.

When the station switching command information is inputted frequently even after the reception of the 1/12-segment broadcasting is started, the chattering preventing unit 11 commands the error concealment mode switching unit 14 to switch the video/audio decoding unit 8a to a mode error concealment mode. When receiving the error concealment mode switching command from the chattering preventing unit 11, the error concealment mode switching unit 14 switches the video/audio decoding unit 8a to the error concealment mode.

When the error concealment mode is set thereto, the video/audio decoding unit 8a performs error concealment on the decoded result of the received data in such a way as to provide data easy for users to view and listen to for the users.

Until now, the case in which the broadcast receiver in accordance with this Embodiment 1 determines whether or not to change the sending-out station from which the broadcast receiver should receive the broadcast wave by using the broadcast display state information or the like acquired at the current position of the vehicle is explained. Next, a case in which the broadcast receiver in accordance with this Embodiment 1 determines whether or not to change the sending-out station from which the broadcast receiver should receive the broadcast wave on the basis of broadcast display state information about the broadcast display state or the like at a predicted position to which vehicle will move will be explained.

First, the movement destination predicting unit 15 receives the current position information about the vehicle acquired by the moving object position acquiring unit 1a, and extracts the information about the current position of the vehicle on a road displayed on a three-dimensional map, and the travelling speed or acceleration of the vehicle from this position information. Next, the movement destination predicting unit 15 compares the current speed or acceleration of the vehicle with a predetermined threshold to determine whether or not the vehicle is traveling at a high speed or accelerating suddenly. In this case, when the current speed or acceleration of the vehicle is higher than the above-mentioned predetermined threshold, and therefore determining that the vehicle is traveling at a high speed or accelerating suddenly, the movement destination predicting unit 15 judges that the vehicle is not changing its traveling direction rapidly, and predicts the position of a movement destination to which the vehicle will move from the current position at the current travelling speed. Information showing this predicted position is outputted from the movement destination predicting unit 15 to the state history extracting unit 9.

The state history extracting unit 9 reads the history information corresponding to the predicted position of the vehicle which is acquired by the movement destination predicting unit 15 from the storage unit 7, and outputs the history information to the station switching judging unit 10. When the history information corresponding to the above-mentioned predicted position of the vehicle isnot stored in the storage unit 7, the state history extracting unit 9 reads history information corresponding to a position at a predetermined distance from the above-mentioned predicted position of the vehicle from the storage unit 7 and outputs the history information to the station switching judging unit 10.

As information including the current broadcast display state information, the station switching judging unit 10 receives the information showing the current reception state from the reception state acquiring unit 3, the current broadcast display state information from the video/audio decoding unit 8a, the current decoding state information from the decoding state acquiring unit 8b, and the current position information about the vehicle from the moving object position acquiring unit 1a. Next, when receiving the history information corresponding to the above-mentioned predicted position from the state history extracting unit 9, the station switching judging unit 10 makes a comparison between the broadcast display state information of this history information and the above-mentioned current broadcast display state information to evaluate them, and determines whether or not to change the sending-out station from which the broadcast receiver should receive the broadcast wave at the predicted position according to this evaluation result. By doing in this way, the broadcast receiver can determine whether or not to change the sending-out station from which the broadcast receiver should receive the broadcast wave promptly on the basis of the predicted position of the vehicle.

The station switching judging unit 10 can also determine whether or not to change the sending-out station from which the broadcast receiver should receive the broadcast wave according to the result of prediction of the reception state by the reception state predicting unit 5.

First, the reception state predicting unit 5 accepts the transmission parameter of the broadcast wave currently being received from the transmission parameter acquiring unit 4, and also receives the information showing the reception state of the broadcast wave currently being received from the reception state acquiring unit 3. Next, the reception state predicting unit 5 compares data showing the reception state of the broadcast wave specified by the above-mentioned transmission parameter with a predetermined threshold value, and, when the data showing the reception state has a value equal to or smaller than the predetermined threshold value, determines that the reception state will further get worse as the vehicle travels.

When predicting that the reception state will get worse as the vehicle travels from the current position, the reception state predicting unit 5 commands the moving object position acquiring unit 1a to acquire the current position information about the vehicle. The current position information about the vehicle acquired by the moving object position acquiring unit 1a is outputted to the state history extracting unit 9.

The state history extracting unit 9 reads the history information corresponding to the current position of the vehicle on the basis of the current position information about the vehicle inputted thereto from the moving object position acquiring unit 1a from the storage unit 7, and outputs the history information to the station switching judging unit 10. The station switching judging unit 10 compares the current broadcast display state information with the past broadcast display state information included in the history information corresponding to the current position of the vehicle to evaluate them, and determines whether or not to change the sending-out station from which the broadcast receiver should receive the broadcast wave according to this evaluation result. In this way, by determining whether or not to change the sending-out station from which the broadcast receiver should receive the broadcast wave according to the result of the prediction of the reception state by the reception state predicting unit 5, the broadcast receiver can provide a switching time at which to switch to another sending-out station in the future even if the broadcast receiver is receiving the broadcast wave from the currently-selected sending-out station satisfactorily.

In addition, the station switching judging unit 10 can determine whether or not to change the sending-out station from which the broadcast receiver should receive the broadcast wave according to a line-of-sight state of the broadcast wave between the vehicle and the sending-out station.

First, the sending-out station line-of-sight determining unit 16 accepts the current position information about the vehicle (information showing the current position, traveling direction, and speed of the vehicle) from the moving object position acquiring unit 1a, and also receives map information including the current position of the vehicle and the position of the sending-out station on a three-dimensional map from the car navigation device 1.

Next, the sending-out station line-of-sight determining unit 16 analyzes whether or not a huge building, a mountain, or the like (an obstacle having a predetermined size or larger) is located between the current position of the vehicle and the position of the sending-out station on the basis of the information about the current position of the vehicle and the map information from the car navigation device 1 to determine whether or not the broadcast wave from the sending-out station is in a line-of-sight state in which the broadcast wave has a line-of-sight path between the current position of the vehicle and the sending-out station, and how long the line-of-sight state will continue from the current position on the basis of this analysis result. This determination result is sent from the sending-out station line-of-sight determining unit 16 to the station switching judging unit 10. As a result, the station switching judging unit 10 refers to the result of the determination of the line-of-sight state of the broadcast wave at the current position and how long the line-of-sight state will continue from the current position, and judges whether or not to change the sending-out station from which the broadcast receiver should receive the broadcast wave.

The broadcast receiver in accordance with this Embodiment 1 can be alternatively configured as follows. For example, the state history extracting unit 9 monitors the amount of history information stored in the storage unit 7. In this case, when a predetermined amount of history information is stored, the state history extracting unit 9 determines the threshold used for the above-mentioned determining process on the basis of the descriptions of the history information stored in the storage unit 7 and by using an SVM (SUPPORT VECTOR MACHINE) method.

For example, when a predetermined amount of information showing the reception state corresponding to a certain point is stored in the storage unit, the state history extracting unit analyzes the change tendency of the reception state by using the SVM to determine the threshold regarding the information showing the reception state in consideration of this change tendency. The threshold for determination determined by the state history extracting unit 9 is set to the reception state determining unit 10b that carries out a determination about the reception state. By doing in this way, the broadcast receiver can change the threshold for determination according to the change tendency of the reception state or the like which is caused by travel of the vehicle.

In a case in which the tuner module 2 is a plurality of multi-tuners, the station switching unit 12 is configured in such a way as to perform the switching between stations on one of the receiving units of the tuner module 2 while not performing the switching between stations on the remaining receiving unit, and the reception state acquiring unit 3 is configured in such a way as to monitor the reception states of the above-mentioned remaining receiving units.

As mentioned above, the broadcast receiver in accordance with this Embodiment 1 stores history information about switching between sending-out stations including broadcast display state information showing the display state of a broadcast wave in the storage unit 7 while bringing the history information into correspondence with position information about the vehicle, compares current broadcast display state information acquired at the current position of the vehicle with broadcast display state information in history information extracted from the storage unit 7 and corresponding to the same position as the current position, and determines, as the switching destination, a sending-out station corresponding to history information which provides the same display state as that of the broadcast wave currently being received as the vehicle travels. The broadcast receiver changes the sending-out station from which the broadcast receiver receives the broadcast wave according to this determination result. By thus comparing the past broadcast display state information in the history information stored in the storage unit 7 with the current broadcast display state information to evaluate the reliability of the history information, the broadcast receiver can carry out the switching between sending-out stations with a high degree of precision.

Furthermore, in above-mentioned Embodiment 1, when history information corresponding to a desired position is not stored in the storage unit 7, the state history extracting unit 9 extracts history information corresponding to a position neighboring to the desired position and outputs this history information to the station switching judging unit 10. As a result, the broadcast receiver can predetermine whether the broadcast receiver should carry out the switching between stations at the time when the vehicle moves to the neighboring position.

In addition, the broadcast receiver in accordance with above-mentioned Embodiment 1 has the dynamically-changing-units-of-information storage change commanding unit 6b that merges a grid area or road region corresponding to history information which has been neither updated nor read, among the history information stored in the storage unit 7, within a predetermined time period with a neighboring grid area or road region, and stores, as history information corresponding to the merged areas or road regions, the history information about those grid areas or road regions in the storage unit 7. As a result, the broadcast receiver can use the storage area of the storage unit 7 efficiently. Furthermore, because the storage unit areas of history information which have been neither updated nor read within the predetermined time period are extended, this history information is hard to search for when the broadcast receiver searches through the storage unit 7 on the basis of the vehicle position. Therefore, the broadcast receiver can also improve its searching performance.

In addition, because the broadcast receiver in above mentioned Embodiment 1 determines whether or not to carry out the switching between sending-out stations with reference to the movement destination and speed of the vehicle, and the road along which the vehicle is traveling, the broadcast receiver can predetermine whether or not to carry out the switching between sending-out stations at the predicted position to which the vehicle is predicted to move in near future.

In addition, the broadcast receiver in accordance with above-mentioned Embodiment 1 includes the line-of-sight determining unit 16 for, on the basis of the position information about the vehicle and the map information including the position of the vehicle and the position of the sending-out station, determining whether the line-of-sight path of the broadcast wave between the sending-out station and the vehicle falls within a permissible range. As a result, the broadcast receiver can judge how long the reception state of the broadcast wave which has gotten worse due to a obstacle existing between the vehicle and the sending-out station continues, and can carry out the switching between sending-out stations at an appropriate time.

Furthermore, the broadcast receiver in accordance with above-mentioned Embodiment 1 monitors the intervals at which it carries out the switching between sending-out stations, and carries out switching to reception of 1/12-segment broadcasting and switching to error concealment mode for video and audio decoding. As a result, the broadcast receiver can improve the possibility of viewing and listening to a broadcast wave.

In addition, the broadcast receiver in accordance with above-mentioned Embodiment 1 dynamically changes the threshold which is reference information to be compared with history information by using the SVM when determining whether or not to carry out the switching between sending-out stations. As a result, the broadcast receiver can dynamically change the threshold according to the receiving environment at the movement destination of the vehicle, and can carry out the switching between sending-out stations appropriately.

### INDUSTRIAL APPLICABILITY

As mentioned above, because the broadcast receiver in accordance with the present invention can switch appropriately between broadcasts providing an identical content which are transmitted via different broadcast waves sent out from different sending-out stations to receive one of the broadcasts, the broadcast receiver in accordance with the present invention is suitable for use as a vehicle-mounted digital broadcasting receiver or the like.

1. A broadcast receiver comprising:
a receiving unit for receiving a broadcast wave sent out from a sending-out station;
a position acquiring unit for acquiring position information about a position of a moving object in which said broadcast receiver is mounted;
a broadcast display state acquiring unit for acquiring broadcast display state information showing a display state of the broadcast wave received by said receiving unit every time said moving object travels a distance;
a storage unit for storing history information about switching between sending-out stations, the history information including the broadcast display state information, while bringing the history information into correspondence with the position information about the position of said moving object;
an extracting unit for extracting history information from said storage unit;
a determining unit for comparing current broadcast display state information acquired at a current position of said moving object with broadcast display state information in history information which is extracted from said storage unit by said extracting unit and which corresponds to a position which is same as the current position to determine that a sending-out station corresponding to history information which provides a display state which is same as a display state of a broadcast wave currently being received as said moving object travels is a switching destination; and
a switching unit for changing the sending-out station from which to receive the broadcast wave by using said receiving unit according to a switching command from said determining unit.

2. The broadcast receiver according to claim 1, characterized in that the broadcast receiver includes a reception state acquiring unit for acquiring information showing a reception state of the broadcast wave from the receiving unit, and the determining unit determines whether or not the reception state of the broadcast wave has a predetermined allowable level on a basis of the information showing the reception state acquired by said reception state acquiring unit, and judges whether or not to change the sending-out station from which to receive the broadcast wave by using the receiving unit according to a result of this determination.

3. The broadcast receiver according to claim 2, characterized in that the broadcast receiver includes a reception state predicting unit for predicting a change tendency of the reception state which is caused by travel of the moving object on a basis of the information showing the reception state acquired by the reception state acquiring unit, and the determining unit judges whether or not to change the sending-out station from which to receive the broadcast wave by using the receiving unit according to a result of the prediction by said reception state predicting unit.

4. The broadcast receiver according to claim 2, characterized in that the determining unit accepts the information showing the reception state from the reception state acquiring unit as the moving object travels to analyze a change tendency of the reception state, and, when a result of the analysis showing that there is a tendency for said reception state to get worse is acquired, determines that the sending-out station from which to receive the broadcast wave by using the receiving unit should be changed.

5. The broadcast receiver according to claim 1, characterized in that the broadcast display state acquiring unit includes a playback unit for playing back received data of a broadcast wave to acquire broadcast display state information, and an error information acquiring unit for acquiring information showing an error frequency with which errors occur in the data playback by said playback unit, and the determining unit determines whether or not a playback state of the received data of the broadcast wave is at a predetermined level on a basis of information showing the error frequency acquired by said error information acquiring unit, and judges whether or not to change the sending-out station from which to receive the broadcast wave by using the receiving unit according to a result of said determination.

6. The broadcast receiver according to claim 5, characterized in that the determining unit receives the information showing the error frequency from the error information acquiring unit as the moving object travels to analyze a change tendency of the playback state of the received data, and, when a result of the analysis showing that there is a tendency for said playback state to get worse is acquired, determines that the sending-out station from which to receive the broadcast wave by using the receiving unit should be changed.

7. The broadcast receiver according to claim 1, characterized in that the position acquiring unit acquires, as position information, a traveling speed of the moving object as well as the position of the moving object, and the determining unit compares a current traveling speed of said moving object with a traveling speed in history information corresponding to the current position, and, when the current traveling speed is higher than the traveling speed in said history information, determines that an amount of noise in a current receiving environment is larger than that in a receiving environment in which said history information was acquired, whereas when the current traveling speed is lower than the traveling speed in said history information, the determining unit determines that the amount of noise in the current receiving environment is smaller than that in the receiving environment in which said history information was acquired.

8. The broadcast receiver according to claim 1, characterized in that the position acquiring unit acquires, as position information, a traveling direction of the moving object as well as the position of the moving object, and the determining unit compares a current traveling direction of said moving object with a traveling direction in history information corresponding to the current position, and, when the current traveling direction is same as the traveling direction in said history information, refers to history information corresponding to position information including this traveling direction for determination of whether or not to carry out the switching between sending-out stations, whereas when the current traveling direction is different from the traveling direction in said history information, the determining unit does not refer to the history information corresponding to the position information including this traveling direction for the determination of whether or not to carry out the switching between sending-out stations.

9. The broadcast receiver according to claim 1, characterized in that the broadcast receiver has a line-of-sight determining unit for, on a basis of the position information about the moving object and map information including the position of said moving object and a position of the sending-out station, determining whether a line-of-sight path of the broadcast wave between said sending-out station and said moving object falls within a permissible range.

10. The broadcast receiver according to claim 1, characterized in that the position acquiring unit acquires, as position information, a traveling speed or an acceleration of the moving object as well as the position of the moving object, and the determining unit determines whether or not the vehicle is traveling at a high speed or suddenly accelerating on a basis of a result of a comparison between said traveling speed or said acceleration and a predetermined threshold, and, when determining that the vehicle is traveling at a high speed or suddenly accelerating, refers to history information corresponding to position information including this traveling speed or acceleration for determination of whether or not to carry out the switching between sending-out stations, whereas when determining that the vehicle is not traveling at a high speed or suddenly accelerating, the determining unit does not refer to the history information corresponding to the position information including the traveling speed or acceleration for the determination of whether or not to carry out the switching between sending-out stations.

11. The broadcast receiver according to claim 1, characterized in that the broadcast receiver includes a chattering preventing unit for storing a switching command from the determining unit when the switching command has occurred repeatedly within a fixed time interval and for setting a newest switching command to the switching unit after said fixed time interval has elapsed.

12. The broadcast receiver according to claim 1, characterized in that the broadcast receiver includes a storage commanding unit for storing the history information in the storage unit in units of storage by defining, as the units of storage, either equal fixed-sized grid areas into which a whole area on a map is divided or road regions each having a fixed distance, and a storage unit changing unit for merging one of said grid areas or said road regions which corresponds to history information which has been neither update-d nor read within a predetermined time period with a neighboring grid area or road region to store said history information in the storage unit as history information corresponding to the merged grid areas or road regions.

13. The broadcast receiver according to claim 1, characterized in that when no history information corresponding to a desired position is stored in the storage unit, the extracting unit extracts history information corresponding to a position neighboring to said desired position and outputs the history information to a discriminating unit.

14. The broadcast receiver according to claim 5, characterized in that the broadcast receiver includes an error concealment mode switching unit for switching the playback unit to an operation mode in which the playback unit performs error concealment on data to be played back of the broadcast wave.

15. The broadcast receiver according to claim 1, characterized in that when the history information stored in the storage unit reaches a certain amount, the extracting unit determines reference information to be compared with the history information when the determining unit determines whether or not to carry out the switching between sending-out stations on a basis of the history information and by using SVM (Support Vector Machine).

16. The broadcast receiver according to claim 1, characterized in that the broadcast receiver has a moving-object-to-moving-object communication unit for acquiring history information from a broadcast receiver mounted in another moving object.
